(19) United States
(12) Patent Application Publication
(10) Pub. No.: US 2023/0117709 A1
(43) Pub. Date: Apr. 20, 2023

(54) DYNAMIC CALCULATION METHOD AND DEVICE OF ELECTRIC VEHICLE MASS

(71) Applicant: Weifeng LIU, Dalian (CN)

(72) Inventor: Weifeng LIU, Dalian (CN)

(21) Appl. No.: 18/064,466

(22) Filed: Dec. 12, 2022

Related U.S. Application Data
(63) Continuation of application No. PCT/CN2022/092589, filed on May 13, 2022.

(30) Foreign Application Priority Data
Aug. 2, 2021 (CN) 202110879948.9
Apr. 27, 2022 (CN) 202210454408.0

(51) Int. Cl. G01G 19/08

(52) U.S. Cl. CPC G01G 19/086

(57) ABSTRACT

A dynamic calculation method and device of electric vehicle mass includes acquiring status data of a vehicle to be measured during an accelerating driving period, the status data including time, speed, height, gravitational acceleration, effective driving power and resistance power; according to the status data information, calculating the total output work, the total resistance work, the total potential energy change amount and the kinetic energy change amount of the vehicle to be measured during the accelerating driving period. Calculating, on the basis of the total output work of a vehicle drive motor being equal to the sum of the total resistance work, a total potential energy change amount of the vehicle in height and the kinetic energy change amount of the vehicle, the mass of the vehicle to be measured.

### TECHNICAL FIELD

The present invention relates to the technical field of traffic, and particularly, to a dynamic calculation method and device of electric vehicle mass.

### BACKGROUND

Battery Electric Vehicle (BEVs) are vehicles that are powered by on-board power batteries, have wheels driven by motors to travel, and conform to various requirements of road traffic and safety regulations. Because the BEVs have less impact on the environment compared with conventional vehicles, the prospect of BEVs is widely optimistic. The main operating principles are mainly as follows: battery (for example, a storage battery and a fuel cell, etc.) — a current — a power regulator — an electric motor — a power transmission system — driving a vehicle to travel (road).

At the present stage, BEVs are developing rapidly, and various vehicle models change every day. Before a vehicle leaves the factory, various groups of performance parameters are required to be measured, including an electric vehicle mass value. A present method for testing the electric vehicle mass is: a floor scale weighing method or a vehicle chassis deformation-based vehicle weighing method. According to a vehicle load detection method, a height sensor is mounted on a vehicle suspension, a deformation amount of the suspension after being pressed is detected, and then a load weight on the suspension is calculated in combination with a pressure-deformation curve and algorithms such as tilt compensation. For the former method, weighing locations are restricted, and vehicles can only be weighed at locations having floor scales and in static conditions, which is inconvenient. For the latter method, the mounting cost is high, and detection precision is not too high.

### SUMMARY

In order to solve the technical problem above, the present invention provides a dynamic calculation method and device of electric vehicle mass, capable of dynamically obtaining the mass of an electric vehicle in real time. Moreover, the measurement precision is high, and the cost is low.

In order to achieve the purpose above, the technical solution of the present invention is as follows:
A dynamic calculation method of electric vehicle mass includes the following steps:
acquiring status data of a vehicle to be measured during an accelerating driving period, the status data including time, speed, height, gravitational acceleration, effective driving power and resistance power;
according to the status data information, calculating the total output work, the total resistance work, the total potential energy change amount and the kinetic energy change amount of the vehicle to be measured during the accelerating driving period; and
on the basis of the Law of conservation of energy, i.e., the total output work of a vehicle drive motor being equal to the sum of the total resistance work, the total potential energy change amount of the vehicle in height and the kinetic energy change amount of the vehicle, calculating the mass of the vehicle to be measured.
preferably, the total potential energy change amount of the vehicle to be measured ΔE_{vehicle} ₕ is
$$Δ {E}_{v e h i c l e h} = {M}_{v e h i c l e} * g * Δ {h}_{v e h i c l e}$$
where M_{vehicle} is the mass of the vehicle, g is the gravitational acceleration, and Δh_{vehicle} is a height difference of the center of gravity of the vehicle between moment t1 and moment t2;
a kinetic energy change of the vehicle to be measured ΔE_{vehicle} ᵥ is
$$Δ {E}_{v e h i c l e v} = 1 / 2 * {M}_{v e h i c l e} * \left(v 2 * v 2 - v 1 * v 1\right)$$
where v1 is a speed of the vehicle at a start moment t1, and v2 is a speed of the vehicle at an end moment t2 (v2 > v1); and
on the basis of the Law of conservation of energy,
$$\begin{matrix}{\text{W}}_{d r i v e m o t o r} = {W}_{r e s i s t a n c e} + ( {M}_{v e h i c l e} ∗ g ∗ Δ {\text{h}}_{v e h i c l e} ) \\ + 1 / 2 * {M}_{v e h i c l e} ∗ ( v 2 ∗ v 2 - v 1 ∗ v \text{1)}\end{matrix}$$
then the mass of the vehicle to be measured M_{vehicle} is:
$$\begin{matrix}{M}_{v e h i c l e} = \\ \left(\left({W}_{d r i v e m o t o r} - {W}_{r e s i s t a n c e}\right) * 2\right) / \left(2 * g * Δ {h}_{v e h i c l e} + v 2 * v 2 - v 1 * v 2\right)\end{matrix}$$
where W_{drive} ₘₒₜₒᵣ is the total output work, and W_{resistance} is the total resistance work.

Preferably, the total resistance work includes the sum of the transmission system resistance work and the vehicle driving resistance work.

Preferably, the transmission system resistance work and the vehicle driving resistance work are both obtained by a real vehicle test.

A dynamic calculation device of electric vehicle mass includes:
an acquisition module, configured to acquire status data of a vehicle to be measured during an accelerating driving period and send to a processing module, the status data including time, speed, height, gravitational acceleration, effective driving power and resistance power;
the processing module, configured to calculate, on the basis of the status data information, total output work, total resistance work, total potential energy change amount and kinetic energy change amount of the vehicle to be measured during the accelerating driving period, and configured to, on the basis of the Law of conservation of energy, i.e., the total output work of a vehicle drive motor being equal to the sum of the total resistance work, a total potential energy change amount of the vehicle in height and the kinetic energy change amount of the vehicle, calculate the mass of the vehicle to be measured.

Preferably, the total potential energy change amount of the vehicle to be measured ΔE_{vehicle} ₕ is

$$Δ {E}_{v e h i c l e h} = {M}_{v e h i c l e} * g * Δ {h}_{v e h i c l e}$$

where M_{vehicle} is the mass of the vehicle, g is the gravitational acceleration, and Δh_{vehicle} is a height difference of the center of gravity of the vehicle between moment t1 and moment t2;
a kinetic energy change of the vehicle to be measured AE_{vehicle} ᵥ is
$$Δ {E}_{v e h i c l e v} = 1 / 2 * {M}_{v e h i c l e} * \left(v 2 * v 2 - v 1 * v 1\right)$$
where v1 is a speed of the vehicle at a start moment t1, and v2 is a speed of the vehicle at an end moment t2 (v2 > v1); and
on the basis of the Law of conservation of energy,
$$\begin{matrix}{\text{W}}_{d r i v e m o t o r} = {W}_{r e s i s t a n c e} + ( {M}_{v e h i c l e} ∗ g ∗ Δ {\text{h}}_{v e h i c l e} ) \\ + 1 / 2 * {M}_{v e h i c l e} ∗ ( v 2 ∗ v 2 - v 1 ∗ v \text{1)}\end{matrix}$$
then the mass of the vehicle to be measured M_{vehicle} is:
$$\begin{matrix}{\text{M}}_{v e h i c l e} = \\ \left(\left({W}_{d r i v e m o t o r} - {W}_{r e s i s t a n c e}\right) ∗ 2\right) / \left(2 ∗ g ∗ Δ {h}_{v e h i c l e} + v 2 ∗ v 2 - v 1 ∗ v 1\right)\end{matrix}$$
where W_{drive} ₘₒₜₒᵣ is the total output work, and W_{resistance} is the total resistance work.

Preferably, the total resistance work includes the sum of the transmission system resistance work and the vehicle driving resistance work.

Preferably, the transmission system resistance work and the vehicle driving resistance work are both obtained by a real vehicle test.

Based on the technical solutions above, the present invention has the following beneficial effects:
1. According to the present invention, an electric vehicle is placed above an appropriate empty space, a vehicle mass calculation module assembly is mounted above the electric vehicle, then a drive motor is started for a period of time to accelerates the electric car to travel a distance, status values of the electric vehicle are obtained by cooperation between the electric vehicle, wheels, the drive motor, the vehicle mass calculation module assembly and a vehicle bus interface, and the vehicle mass can be easily and quickly calculated on the basis of the obtained status values. The measurement method of the present invention is less restricted by sites, the real-time vehicle mass can also be measured in a normal driving process of the vehicle, the measurement is convenient and quick, and the measurement precision is high.
2. The present invention has less additional hardware requirements and low mounting cost, and can be implemented by upgrading related software. The implementation cost is low.

### BRIEF DESCRIPTION OF THE DRAWINGS

FIG. 1 is the flowchart of the dynamic calculation method of electric vehicle mass in one embodiment;

FIG. 2 is the schematic structural diagram of the dynamic calculation device of electric vehicle mass.

### DETAILED DESCRIPTION

The technical solutions in embodiments of the present invention are clearly and completely described below with reference to the accompanying drawings in the embodiments of the present invention.

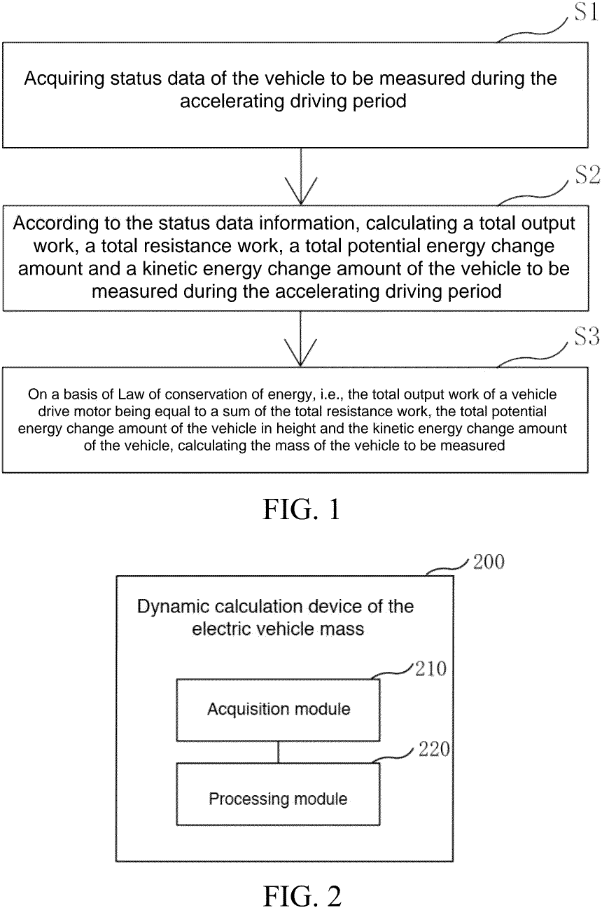

As shown in FIG. 1, a dynamic calculation method of electric vehicle mass provided by the embodiment includes the following steps:

At S1, status data of a vehicle to be measured during an accelerating driving period is acquired, the status data including time, speed, height, gravitational acceleration, effective driving power and resistance power.

Specifically, a vehicle mass calculation module assembly is mounted above the vehicle to be measured, i.e., the electric vehicle. A plurality of modules for calculation, sensing and induction, etc., for example, a height sensor, are mounted in the vehicle mass calculation module assembly. At the present stage, a wide variety of modules are produced and sold on the market, and can satisfy the measurement requirements of the vehicle mass calculation module assembly in the present embodiment. Therefore, details about the vehicle mass calculation module assembly are not described herein again and can completely be implemented by a person skilled in the art. A vehicle bus interface is provided at the upper front side of the vehicle mass calculation module assembly. The vehicle bus interface (including the Internet of vehicles, a can bus, a lin bus, and a serial port, etc.) performs transmission to an on-board computer. A display mode includes: display on a screen of the on-board computer, display on a vehicle diagnosis instrument, display on an external computer, and display on an external server.

The electric vehicle is placed above an appropriate empty space, a drive motor is started for a period of time to accelerates the electric car to travel a distance, the vehicle mass calculation module assembly is connected to a vehicle bus, a vehicle Electronic Control Unit (ECU) and the on-board computer by means of the vehicle bus interface, and status values of the electric vehicle are obtained by cooperation between the electric vehicle, wheels, the drive motor, the vehicle mass calculation module assembly and the vehicle bus interface:
t1: a start moment of the vehicle mass calculation;
t2: an end moment of the vehicle mass calculation;
v1: a speed of the vehicle at t1;
v2: a speed of the vehicle at t2; (note: v2 > v1)
P_{drive} ₘₒₜₒᵣ : an effective driving power (or effective output power) of the vehicle drive motor;
P_{resistance}: power of resistance of the vehicle, including but not limited to power of air resistance, tire resistance, and transmission resistance, etc.;
g: the gravitational acceleration; and
Δh_{vehicle}: a height difference of the center of gravity of the vehicle between t1 and t2.

At S2, according to the status data information, total output work, total resistance work, total potential energy change amount and kinetic energy change amount of the vehicle to be measured during the accelerating driving period are calculated.

Specifically, after obtaining the status data information above, the on-board computer performs calculation to obtain:
the total output work of the drive motor W_{drive} ₘₒₜₒᵣ:
$${W}_{d r i v e m o t o r} = {\int }_{{t}_{1}}^{{t}_{2}} {P}_{d r i v e m o t o r} d t$$
the total resistance work W_{resistance}:
$${W}_{r e s i s t a n c e} = {\int }_{{t}_{1}}^{{t}_{2}} {P}_{r e s i s t a n c e} d t$$
the total potential energy change amount of the vehicle to be measured ΔE_{vehicle} ₕ:
$$Δ {E}_{v e h i c l e h} = {M}_{v e h i c l e} ∗ \text{g} ∗ Δ {\text{h}}_{v e h i c l e}$$
where M_{vehicle} is the mass of the vehicle, g is the gravitational acceleration, and Δh_{vehicle} is a height difference of the center of gravity of the vehicle between moment t1 and moment t2;
a kinetic energy change of the vehicle to be measured ΔE_{vehicle v}:
$$Δ {E}_{v e h i c l e v} = 1 / 2 ∗ {M}_{v e h i c l e} ∗ \left(v 2 ∗ v 2 - v 1 ∗ v 1\right)$$
where v1 is a speed of the vehicle at the start moment t1, and v2 is a speed of the vehicle at the end moment t2 (v2 > v1).

At S3, on the basis of the Law of conservation of energy, i.e., the total output work of the vehicle drive motor being equal to the sum of the total resistance work, the total potential energy change amount of the vehicle in height and the kinetic energy change amount of the vehicle, the mass of the electric vehicle is calculated.

Specifically, according to the Law of conservation of energy, the total output work of the vehicle drive motor is equal to the sum of the work done by resistance of the transmission system, the work done by driving resistance of the vehicle (including the work done by air resistance, the work done by tire resistance, and the work done by other resistance), the potential energy change amount of the vehicle in height and the kinetic energy change of the vehicle. For one type of models or one vehicle in electric vehicles, information about the resistance and the work done by the resistance of the transmission system, and the driving resistance and the work done by the resistance of the vehicle is obtained by a real vehicle test in advance, and is stored in the vehicle mass calculation module assembly, or in the on-board computer. The specific explanations are as follows:

The work consumed by the transmission system: it is related with the transmission system, and different transmission systems have different transmission resistance. Because the transmission system of an electric vehicle is simple in structure, and the resistance of the transmission systems of electric vehicles of a same model is relatively consistent, the resistance and the work done by the resistance of the transmission system are obtained by a rotational speed and a friction coefficient of the transmission system.

The work done by the driving resistance of the vehicle:
1) The work done by air resistance is related with a vehicle speed and a wind velocity, and in a vehicle appearance development process, a drag coefficient of the vehicle is obtained by a large number of wind tunnel tests. The air resistance and the work done by the air resistance are obtained by combining the drag coefficient, the vehicle speed and the wind velocity.
2) The work done by tire resistance is a characteristic of tires, and different types of tires have different rolling resistance coefficients. Generally, the work done by tire resistance is obtained by combining a rotational speed of tires (affected by the vehicle speed) and the rolling resistance coefficient.

The following calculation equation is obtained according to the above:

$${W}_{d r i v e m o t o r} =$$

$${W}_{r e s i s t a n c e} + Δ {Ε}_{v e h i c l e h} + Δ {E}_{v e h i c l e v} , \text{i} . \text{e} . ,$$

$$\begin{matrix}{W}_{d r i v e m o t o r} = \\ {W}_{r e s i s t a n c e} \text{} + \left({M}_{v e h i c l e} ∗ g ∗ Δ {\text{h}}_{v e h i c l e}\right) + \\ 1 \text{} / \text{} 2 ∗ {M}_{v e h i c l e} ∗ \left(v 2 ∗ v 2 - \text{} v 1 ∗ v 1\right)\end{matrix}$$

then the mass of the vehicle to be measured M_{vehicle} is:

$$\begin{matrix}{M}_{v e h i c l e} = \\ \left(\left({W}_{d r i v e m o t o r} - {W}_{r e s i s t a n c e}\right) ∗ 2\right) / \left(2 ∗ g ∗ Δ {\text{h}}_{v e h i c l e} + v 2 ∗ v 2 - v 1 ∗ v 1\right) .\end{matrix}$$

It is easy to understand that a program and algorithms are implemented in a computer according to the formulas above, and the mass of the vehicle can be directly calculated by the on-board computer.

The vehicle mass calculation module assembly can be implemented in an external server. The on-board computer can transmit data required for vehicle mass calculation to the external server via a network, and then the external server dynamically calculates the vehicle mass of the vehicle according to the status data uploaded by the vehicle.

The processes are as follows: acquiring data, transmitting data to a network module via a vehicle bus (including the Internet of vehicles, a can bus, a lin bus, and a serial port, etc.), uploading, by the network module, the data to the external server, and performing calculation, by the external server, according to the uploaded data to obtain the real-time vehicle mass of the vehicle.

As shown in FIG. 2, a dynamic calculation device 200 of electric vehicle mass provided by the embodiment includes:
an acquisition module 210, configured to acquire status data of a vehicle to be measured during an accelerating driving period and send to a processing module, the status data including time, speed, height, gravitational acceleration, effective driving power and resistance power; and
the processing module 220, configured to calculate, on the basis of the status data information, total output work, total resistance work, total potential energy change amount and kinetic energy change amount of the vehicle to be measured during the accelerating driving period, and configured to, on the basis of the Law of conservation of energy, i.e., the total output work of a vehicle drive motor being equal to the sum of the total resistance work, a potential energy change amount of the vehicle in height and the kinetic energy change amount of the vehicle, calculate the mass of the vehicle to be measured.

It should be noted that a vehicle mass calculation module assembly is mounted above the vehicle to be measured, i.e., the electric vehicle. A plurality of modules for calculation, sensing and induction, etc., for example, a height sensor, are mounted in the vehicle mass calculation module assembly. At the present stage, a wide variety of modules are produced and sold on the market, and can satisfy the measurement requirements of the vehicle mass calculation module assembly in the present embodiment. Therefore, details about the vehicle mass calculation module assembly are not described herein again and can completely be implemented by a person skilled in the art. A vehicle bus interface is provided at the upper front side of the vehicle mass calculation module assembly. The vehicle bus interface (including the Internet of vehicles, a can bus, a lin bus, and a serial port, etc.) performs transmission to an on-board computer. A display mode includes: display on a screen of the on-board computer, display on a vehicle diagnosis instrument, display on an external computer, and display on an external server.

The electric vehicle is placed above an appropriate empty space, a drive motor is started for a period of time to accelerates the electric car to travel a distance, the vehicle mass calculation module assembly is connected to a vehicle bus, a vehicle Electronic Control Unit (ECU) and the on-board computer by means of the vehicle bus interface, and status values of the electric vehicle are obtained by cooperation between the electric vehicle, wheels, the drive motor, the vehicle mass calculation module assembly and the vehicle bus interface:
t1: a start moment of the vehicle mass calculation;
t2: an end moment of the vehicle mass calculation;
v1: a speed of the vehicle at t1;
v2: a speed of the vehicle at t2; (note: v2 > v1)
P_{drive} ₘₒₜₒᵣ : an effective driving power (or effective output power) of the vehicle drive motor;
P_{resistance}: power of resistance of the vehicle, including but not limited to power of air resistance, tire resistance, and transmission resistance, etc.;
g: the gravitational acceleration; and
Δh_{vehicle}: a height difference of the center of gravity of the vehicle between t1 and t2.

After the status data information of the electric vehicle is obtained, the vehicle mass can be directly calculated by the on-board computer.

Or, the on-board computer can transmit data required for vehicle mass calculation to the external server via a network, and then the external server dynamically calculates the vehicle mass of the vehicle according to the status data uploaded by the vehicle. The calculation is as follows:
the total output work of the drive motor W_{drive} ₘₒₜₒᵣ:
$${W}_{d r i v e m o t o r} = {\int }_{{t}_{1}}^{{t}_{2}} {P}_{d r i v e m o t o r} d t$$
the total resistance work W_{resistance}:
$${W}_{r e s i s t a n c e} = {\int }_{{t}_{1}}^{{t}_{2}} {P}_{r e s i s t a n c e} d t$$
the total potential energy change amount of the vehicle to be measured ΔE_{vehicle} ₕ:
$$Δ {E}_{v e h i c l e h} = {M}_{v e h i c l e} ∗ g ∗ Δ {\text{h}}_{v e h i c l e}$$
where M_{vehicle} is the mass of the vehicle, g is the gravitational acceleration, and Δh_{vehicle} is a height difference of the center of gravity of the vehicle between moment t1 and moment t2;
a kinetic energy change of the vehicle to be measured AE_{vehicle v}:
$$Δ {E}_{v e h i c l e v} = 1 / 2 * {M}_{v e h i c l e} * \left(v 2 * v 2 - v 1 * v 1\right)$$
where v1 is a speed of the vehicle at the start moment t1, and v2 is a speed of the vehicle at the end moment t2 (v2 > v1).

It should be noted that according to the Law of conservation of energy, the total output work of the vehicle drive motor is equal to the sum of the work done by resistance of the transmission system, the work done by driving resistance of the vehicle (including the work done by air resistance, the work done by tire resistance, and the work done by other resistance), the potential energy change amount of the vehicle in height and the kinetic energy change of the vehicle. For one type of models or one vehicle in electric vehicles, information about the resistance and the work done by the resistance of the transmission system, and the driving resistance and the work done by the resistance of the vehicle is obtained by a real vehicle test in advance, and is stored in the vehicle mass calculation module assembly, or in the on-board computer. The specific explanations are as follows:

The work consumed by the transmission system: it is related with the transmission system, and different transmission systems have different transmission resistance. Because the transmission system of an electric vehicle is simple in structure, and the resistance of the transmission systems of electric vehicles of a same model is relatively consistent, the resistance and the work done by the resistance of the transmission system are obtained by a rotational speed and a friction coefficient of the transmission system.

The work done by the driving resistance of the vehicle:
1) The work done by air resistance is related with a vehicle speed and a wind velocity, and in a vehicle appearance development process, a drag coefficient of the vehicle is obtained by a large number of wind tunnel tests. The air resistance and the work done by the air resistance are obtained by combining the drag coefficient, the vehicle speed and the wind velocity.
2) The work done by tire resistance is a characteristic of tires, and different types of tires have different rolling resistance coefficients. Generally, the work done by tire resistance is obtained by combining a rotational speed of tires (affected by the vehicle speed) and the rolling resistance coefficient.

The following calculation equation is obtained according to the above:

$${\text{W}}_{d r i v e m o t o r} = {W}_{r e s i s t a n c e} + Δ Ε {}_{v e h i c l e h} + Δ {Ε}_{v e h i c l e v} , \text{i} \text{.e} \text{.,}$$

$$\begin{matrix}{W}_{d r i v e m o t o r} = \\ {W}_{r e s i s t a n c e} + \left({M}_{v e h i c l e} * g * Δ {h}_{v e h i c l e}\right) + 1 / 2 * {M}_{v e h i c l e} * \left(v 2 * v 2 - v 1 * v 1\right)\end{matrix}$$

then the mass of the vehicle to be measured M_{vehicle} is:

$${M}_{v e h i c l e} = \left(\left({W}_{d r i v e m o t o r} - {W}_{r e s i s t a n c e}\right) * 2\right) / \left(2 * g * Δ {h}_{v e h i c l e} + v 2 * v 2 - v 1 * v 1\right) .$$

The foregoing descriptions are merely preferred implementations of a dynamic calculation method and device of electric vehicle mass of the present invention, and are not intended to limit the scope of protection of the embodiments of the present invention. Any modification, equivalent replacement, or improvement made without departing from the spirit and principle of the embodiments of the present description shall fall within the scope of protection of the embodiments of the present description.

1. A dynamic calculation method of a mass of an electric vehicle, comprising following steps:
acquiring status data of a vehicle to be measured during an accelerating driving period, the status data comprising time, speed, height, gravitational acceleration, effective driving power and resistance power;
according to the status data information, calculating a total output work, a total resistance work, a total potential energy change amount and a kinetic energy change amount of the vehicle to be measured during the accelerating driving period; and
on a basis of Law of conservation of energy, i.e., the total output work of a vehicle drive motor being equal to a sum of the total resistance work, the total potential energy change amount of the vehicle in height and the kinetic energy change amount of the vehicle, calculating the mass of the vehicle to be measured.

2. The dynamic calculation method of the mass of the electric vehicle according to claim 1, wherein the total potential energy change amount of the vehicle to be measured ΔE_{vehicle} ₕ is
$$Δ {E}_{v e h i c l e h} = {M}_{v e h i c l e} ∗ g ∗ Δ {h}_{v e h i c l e}$$
wherein M_{vehicle} is the mass of the vehicle, g is the gravitational acceleration, and Δh_{vehicle} is a height difference of a center of gravity of the vehicle at moment t1 and moment t2;
a kinetic energy change amount of the vehicle to be measured ΔE_{vehicle v} is
$$Δ {E}_{v e h i c l e v} = 1 / 2 ∗ {M}_{v e h i c l e} ∗ \left(v 2 ∗ v 2 - v 1 ∗ v 1\right)$$
wherein v1 is a speed of the vehicle at a start moment t1, and v2 is a speed of the vehicle at an end moment t2 (v2 > vl); and
on the basis of the Law of conservation of energy, W_{drive} ₘₒₜₒᵣ = W_{resistance} +
$$\left({M}_{v e h i c l e} ∗ \text{g} ∗ Δ {\text{h}}_{v e h i c l e}\right) + 1 / 2 ∗ {M}_{v e h i c l e} ∗ \left(v 2 ∗ v 2 - v 1 ∗ v 1\right)$$
then the mass of the vehicle to be measured M_{vehicle} is:
$$\begin{matrix}{M}_{v e h i c l e} = \\ \left(\left({W}_{d r i v e m o t o r} - {W}_{r e s i s t a n c e}\right) ∗ 2\right) \text{} / \text{} \left(2 ∗ g ∗ Δ {h}_{v e h i c l e} + v 2 ∗ v 2 - v 1 ∗ v 1\right)\end{matrix}$$
wherein W_{drive} ₘₒₜₒᵣ is the total output work, and W_{resistance} is the total resistance work.

3. The dynamic calculation method of the mass of the electric vehicle according to claim 1, wherein the total resistance work comprises a sum of a transmission system resistance work and a vehicle driving resistance work.

4. The dynamic calculation method of the mass of the electric vehicle according to claim 3, wherein the transmission system resistance work and the vehicle driving resistance work are both obtained by a real vehicle test.

5. A dynamic calculation device of the mass of the electric vehicle, comprising:
an acquisition module, configured to acquire status data of a vehicle to be measured during an accelerating driving period and send to a processing module, the status data comprising time, speed, height, gravitational acceleration, effective driving power and resistance power;
the processing module, configured to calculate, on a basis of the status data information, a total output work, a total resistance work, a total potential energy change amount and a kinetic energy change amount of the vehicle to be measured during the accelerating driving period, and configured to, on a basis of Law of conservation of energy, i.e., the total output work of a vehicle drive motor being equal to a sum of the total resistance work, the total potential energy change amount of the vehicle in height and the kinetic energy change amount of the vehicle, calculate the mass of the vehicle to be measured.

6. The dynamic calculation device of the mass of the electric vehicle according to claim 5, wherein the total potential energy change amount of the vehicle to be measured ΔE_{vehicle} ₕ is
$$Δ {E}_{v e h i c l e h} = {M}_{v e h i c l e} ∗ \text{g} ∗ Δ {h}_{v e h i c l e}$$
wherein M_{vehicle} is the mass of the vehicle, g is the gravitational acceleration, and Δh_{vehicle} is a height difference of a center of gravity of the vehicle at moment t1 and moment t2;
a kinetic energy change amount of the vehicle to be measured ΔE_{vehicle v} is
$$Δ {E}_{v e h i c l e v} = 1 / 2 * {M}_{v e h i c l e} ∗ \left(v 2 ∗ v 2 - v 1 ∗ v 1\right)$$
wherein v1 is a speed of the vehicle at a start moment t1, and v2 is a speed of the vehicle at an end moment t2 (v2 > vl); and
on the basis of the Law of conservation of energy, W_{drive} ₘₒₜₒᵣ = W_{resistance} +
$$\left({M}_{v e h i c l e} ∗ g ∗ Δ {\text{h}}_{v e h i c l e}\right) + 1 / 2 * {M}_{v e h i c l e} ∗ \left(v 2 ∗ v 2 - v 1 ∗ v 1\right)$$
then the mass of the vehicle to be measured M_{vehicle} is:
$$\begin{matrix}{M}_{v e h i c l e} = \left(\left({W}_{d r i v e m o t o r} - {W}_{r e s i s t a n c e}\right) * 2\right) / \\ \left(2 ∗ g ∗ Δ {\text{h}}_{v e h i c l e} + v 2 ∗ v 2 - v 1 ∗ v 1\right)\end{matrix}$$
wherein W_{drive} ₘₒₜₒᵣ is the total output work, and W_{resistance} is the total resistance work.

7. The dynamic calculation device of the mass of the electric vehicle according to claim 5, wherein the total resistance work comprises a sum of a transmission system resistance work and a vehicle driving resistance work.

8. The dynamic calculation device of the mass of the electric vehicle according to claim 7, wherein the transmission system resistance work and the vehicle driving resistance work are both obtained by a real vehicle test.
